(19) United States
(12) Patent Application Publication
(10) Pub. No.: US 2024/0003081 A1
(43) Pub. Date: Jan. 4, 2024

(54) PRE-TREATMENT OF FIBERS FOR PRINTING

(71) Applicant: Kornit Digital Ltd., Rosh HaAyin (IL)

(72) Inventors: Nadav MORDECHAI, Tel Aviv (IL); Jacob MANN, Zoran (IL); IIan Shmuel MANO, Ramat-Gan (IL)

(73) Assignee: Kornit Digital Ltd., Rosh HaAyin (IL)

(21) Appl. No.: 18/038,222

(22) PCT Filed: Dec. 8, 2021
(86) PCT No.: PCT/IL2021/051459

§ 371 Date: May 23, 2023

Related U.S. Application Data
(60) Provisional application No. 63/122,513, filed on Dec. 8, 2020.

(51) Int. Cl. D06P 5/20; D06Q 1/12

(52) U.S. Cl. CPC D06P 5/2083; D06Q 1/12; D06P 5/2072

(57) ABSTRACT

Apparatus and method for pre-treatment of synthetic fabrics, for example brushed polyester fabric, prior to printing to prevent fibrillation effects of the fabric on the print quality. The apparatus comprises a printing pre-treatment location where fabric is treated prior to printing and a heat source applying heat to a predefined printing area on the fabric at the printing pre-treatment location. The heat applied is sufficient to fuse outwardly extending fibers of the fabric back into the fabric using thermoplastic deformation, thereby to produce a treated printing area for printing. The apparatus may be online with a printer or may be offline and the heat treatment may optionally be combined with spraying.

### RELATED APPLICATION/S

This application claims the benefit of priority under 35 USC § 119(e) of U.S. Provisional Patent Application No. 63/122,513 filed Dec. 8, 2020, the contents of which are incorporated herein by reference in their entirety.

### FIELD AND BACKGROUND OF THE INVENTION

The present invention, in some embodiments thereof, relates to pre-treatment of fibers for printing and, more particularly, but not exclusively, to a method and apparatus for pre-treatment of synthetic fabric to allow for effective printing thereon.

Synthetic fibers generally a smooth fiber, as compared to cotton which has fibers that stick out. Hence cotton is pretreated by ironing and/or wetting to flatten the fibers prior to printing to prevent loose fibers from getting in the way of printing. Synthetic does not intrinsically have this problem since synthetic fibers are generally smooth. However, prior to printing, fabric may need to be brushed, to free it from loose nap, flocks and dust that it picks up whilst being stored. Furthermore, some fabric types undergo a mechanical abrasion in production, to improve the look and feel of the fabric. The brushing or abrasion processes often have the effect of making fiber ends extend outwardly from the previously smooth fabric surface, causing fibrillation, and the extended fibers may show through a print layer or interfere with the even spread of ink onto the fiber. The brushing/abrasion process often causes fiber ends to extend outwardly from a fabric surface. Extended fibers and fibrillation may cause a range of print quality issues, some not visible to the naked eye until the garments are washed. Such issues may include cracks, known as laydown cracks, in the print surface, where a loose fiber has been printed on and then become detached.

Indeed, it is increasingly common to deliberately use synthetic fabric, in which the synthetic fabrics have been abraded to intentionally produce such extending fibers so that the fabric feels smoother, more like cotton. Brushed polyester is an example. But synthetic fibers cannot simply be wetted or ironed in order to flatten them and prevent them from obstructing printing.

The present disclosure seeks to enable effective and accurate printing on synthetic fabric and like fabrics despite the above limitations.

Example of synthetic fabric with melting temperature—the major known synthetic fabric is polyester fabric Tm=260-290° C. (melting temperature), others are acetate Tm=230-240° C., acrylic Tm=250-260° C., spandex Tm=230-240° C. and nylon Tm=210-220° C.

### SUMMARY OF THE INVENTION

The present embodiments may use heat over the printing area to fuse the fibers of the synthetic fabric back onto the fabric and thus provide a smooth area for printing. The remainder of the fabric is left alone so that the cotton-like feel of the synthetic fabric is retained over the remainder of the garment. The heat source may be non-contact, and singe the fabric prior to treatment to cause thermoplastic deformation to fuse the extending fibers in the treatment area back into the fabric.

It is to be noted that the fabric may for example be 100% synthetic fabric or a blend fabric made of a blend of natural and synthetic fibers.

The pre-treatment process of the present embodiments may eliminate any fabric fibrillation effect and can be used in a pre-treatment stage as part of a fabric printing device as well as in an off-line pre-treatment process.

According to an aspect of some embodiments of the present invention there is provided apparatus for pre-treatment of a synthetic fabric or a blend fabric made of natural fibers such as cotton, and synthetic fibers, the treatment for application prior to printing on the fabric, comprising:
a printing pre-treatment location for treating the fabric prior to providing to a printing location for printing;
a heat source configured to apply heat to a predefined printing area on the fabric at the printing pre-treatment location, the heat being sufficient to fuse outwardly extending fibers of the fabric back into the fabric using thermoplastic deformation, thereby to produce a treated printing area for printing.

In an embodiment, the heat source is a non-contact heat source.

In an embodiment, the non-contact heat source is a flame source.

In an embodiment, the source is heated air, and embodiments may include a nozzle for providing the heated air in a directed manner at the predefined printing area. The heated air may be heated to at least two hundred and fifty degrees Celsius, and temperatures of between 500 degrees Celsius and 600 degrees Celsius have been used in testing.

Typically, the heated air is sufficiently hot to heat the fabric to at least two hundred and fifty degrees Celsius or to any of the other temperatures mentioned.

In an embodiment, the source comprises an air heater for producing the heated air and a blower for blowing the heated air through the nozzle.

In an embodiment, the non-contact heat source comprises a laser source.

In an embodiment, the non-contact heat source comprises an infra-red source.

In an embodiment, the heat source comprises a phased plate heat press, the phased plate heat press comprising edges having a shallow receding angle.

In an embodiment, the phased plate heat press comprises a heating plate and a reaction plate, and the edges having a shallow angle are on the reaction plate.

In an embodiment, the shallow receding angle is between one and six degrees.

Embodiments may include a spray source for spraying the predetermined treatment area with a selected liquid prior to application of heat from the non-contact heat source, and/or after the application of heat.

As an alternative to a single spray source spraying at two locations, embodiments may include a second spray source between the non-contact heat source and the printing area, for spraying the predetermined treatment area after heating and before printing.

Embodiments may include a feeder for feeding the fabric via the fabric pre-treatment location and onwards to a printing location.

According to a further aspect of the present invention there is provided a method of pre-treatment of synthetic fabric, the treatment for application prior to printing, comprising:
placing the fabric at a printing pre-treatment location;
applying heat to a predefined printing area on the fabric at the printing pre-treatment location, the heat fusing outwardly extending fibers of the fabric back into the fabric using thermoplastic deformation, thereby to produce a treated printing area for printing.

In an embodiment, the applying heat comprises heating air to a temperature suitable for thermoplastic deformation and blowing the air through a nozzle to produce a concentrated heat effect (air-knife) on a given location on the fabric.

To cover the entire size of the printed image (up to 600 mm in width), the air-knife may scan the image width back and forth with cross axis steps between the movements. In an embodiment, the applying heat comprises applying a contact heat element to a given location on the fabric for a time not exceeding ten seconds, or not exceeding five seconds, or not exceeding three seconds.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified schematic diagram showing a textile or garment being treated according to an embodiment of the present invention;

FIG. 2 is a simplified flow chart illustrating operation of an embodiment of the present invention;

FIG. 3 is a simplified schematic diagram of heating apparatus with a fabric transfer system for pretreating a fabric according to an embodiment of the present invention;

FIG. 4 is an enhancement of the apparatus of FIG. 3 with a spray bar;

FIG. 5 is an enhancement of the apparatus of FIG. 3 in which two heating devices are suspended from a bridge;

FIGS. 6 and 7 are two views of apparatus in which a single nozzle heating device is suspended from a bridge;

FIGS. 8A and 8B show a fabric after contact-based heating, without and with the present embodiments;

FIG. 9A shows a prior art heat press;

FIG. 9B shows a phased plate heat press according to an embodiment of the present invention;

FIG. 9C shows a detail of an edge of the phased plate with different possible angles for the edges according to embodiments of the present invention; and

FIGS. 10 and 11 show comparisons of fabrics with and without the non-contact embodiments of the present invention.

### DESCRIPTION OF SPECIFIC EMBODIMENTS OF THE INVENTION

The present embodiments relate to a method and apparatus for pre-treatment of fabric made of synthetic fiber, such as brushed polyester fabric, to allow for effective printing thereon.

The present embodiments may provide an apparatus and method for pre-treatment of brushed polyester fabric prior to printing to prevent fibrillation effects of the fabric on the print quality. The apparatus may provide fabric at a printing pre-treatment location at which the fabric is treated prior to printing, and a heat source may apply heat to a predefined printing area on the fabric at the printing pre-treatment location. The heat applied is sufficient to fuse outwardly extending fibers of the fabric back into the fabric using thermoplastic deformation, thus producing a treated printing area for printing. The apparatus may be online with a printer or may be offline and the heat treatment may optionally be combined with spraying immediately prior to the heat treatment to improve the fiber surface quality and/or absorption of ink. Additional spraying may also be provided immediately after the heat treatment to further improve fiber surface quality and/or absorption of ink.

The heat source may be a heat press. Alternatively the heat source may be a non-contact source such as a laser source or an infra-red source or a flame that singes the fabric or a combination of a heater for heating air and a blower for directing the heated air at the fabric. A nozzle may be used to direct the air from the blower to the fabric to provide a sufficient concentration of hot air to cause thermoplastic deformation to occur.

In one embodiment the fabric may be on a feeder being fed towards a printing location and the pre-treatment is provided online with printing as the fabric moves past the heat source. In another embodiment, the heat source may move along the fabric through the pre-treatment location. Such an embodiment is suitable for offline pre-treatment, the fabric later being provided for printing.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

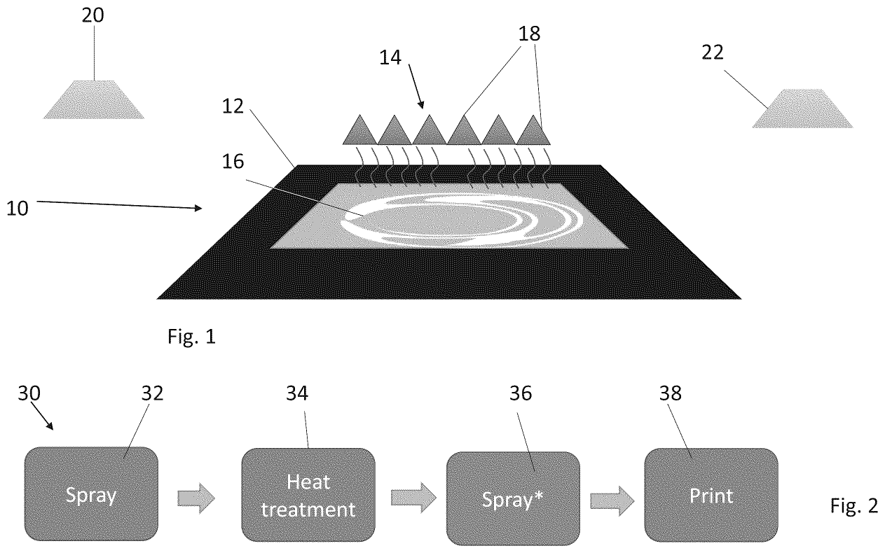

Referring now to the drawings, FIG. 1 illustrates apparatus for pre-treatment of brushed polyester fabric prior to printing according to an embodiment of the present invention. The embodiment comprises a printing pre-treatment location 10 for treating a fabric 12 prior to the fabric being provided for printing. A heat source 14 applies heat to a predefined printing area 16 on the fabric where it is intended to print wording or a design or the like. The heat provided is sufficient to fuse outwardly extending fibers of the fabric back into fabric itself, meaning the main fibers forming the weave of the fabric, using thermoplastic deformation. The result is a treated printing area which can now be printed on without extended or loose fibers getting in the way. The heat source may as shown be a non-contact heat source, for example a laser source, an infra-red source or a flame that singes the fabric. As shown in FIG. 1, the source is heated air which is directed through nozzles 18 to the predefined printing area 16 on the fabric. Whatever the heating system used, a temperature that is sufficient to cause thermoplastic deformation is applied to the surface of the fabric. Thus the heated air may for example be heated to two hundred and fifty degrees Celsius or more, in order to ensure that the fabric experiences a sufficient temperature to have the required effect.

A heating element may heat the air and a blower may blow the heated air through the nozzle or nozzles 18 onto the fabric.

Exemplary air knife parameters are:
1. Dimensions—approx. 200 mm (L)×2 mm (W) to maintain close to constant air flow and temperature throughout its aperture and on the media.
2. Height above media −4-10 mm
3. Air flow −250-300 L/min
4. Temperature outlet from the air-knife 250-400 degrees Celsius

As alternatives to a heating element and a nozzle, heat radiation using an infra-red lamp or heating elements could be used. An open flame burner may also be used.

As an alternative to the non-contact heat sources mentioned above, the heat source may be a heat press which comes into contact with and presses the fabric. Other contact solutions include a heated roller that, like the heat press, enables mechanical pressure as well as heat. A further possibility is a hot cutting wire that floats above the fabric surface, trimming the fibers.

A further possibility is to use a highly viscous material that may be jetted or sprayed onto the garment and then pressed down to flatten the fabric. The viscosity and general stickiness properties may keep the loose fibers flattened at least for the duration of the printing process.

In an embodiment, a spray source 20 sprays the predetermined treatment area with a selected liquid prior to application of heat from the non-contact heat source. The use of spray prior to heating may improve the quality of the surface of the fabric in two ways. First of all it may ensure that the feel of the surface is retained despite the heat treatment, and secondly it may improve the way in which the ink is taken up by the fabric surface, as will be discussed in greater detail hereinbelow. In general a thin layer of liquid spray may protect the fabric surface itself from overheating due to the treatment while at the same time leaving fibers that stick out exposed to the treatment.

In some embodiments, a second spray source 22 is located between the heating area, whether a heat press or a non-contact heat source, and the printing area, so that the surface is sprayed a second time after heating and before printing.

In some embodiments, the spray source 20 is used to spray a second time after heating and before printing.

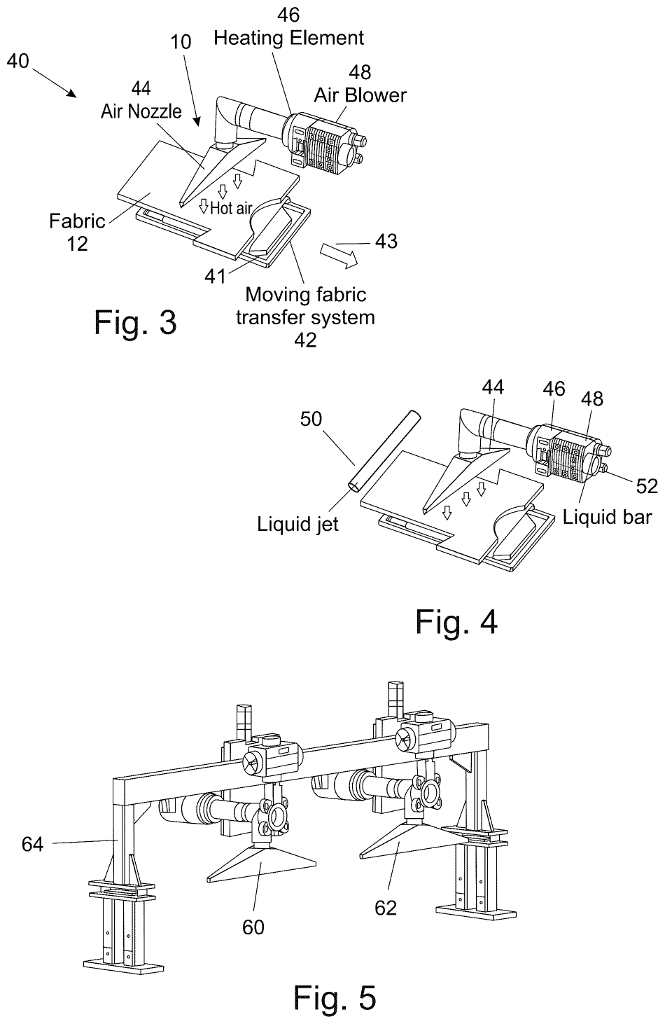

In an embodiment, the fabric is held on a feeder, for example a pallet or the like, and the fabric is fed via the fabric pre-treatment location and onwards to the printing location, so that textile lengths, or garments made from the textile, are continuously picked up by the printing machine, pre-treated, printed and offloaded. The feeder is discussed in greater detail with respect to FIG. 3 below.

Reference is now made to FIG. 2, which is a simplified flow chart showing the processes applied to a textile, or a garment made from the textile, according to embodiments of the present invention.

Specifically, FIG. 2 shows a method 30 of pre-treatment of brushed polyester fabric prior to printing which involves the garment entering a pre-treatment area where firstly, optionally, spray is applied to the garment, 32. Then the heat treatment is applied—34. As discussed, the heat fuses the outwardly extending fibers of the fabric back into the fabric using thermoplastic deformation, to produce a treated printing area. Optionally a second spray stage is applied 36 and finally the textile or garment is printed 38 on the area to which the pre-treatment was applied.

Reference is now made to FIG. 3 which shows an embodiment 40 of the device of FIG. 1. A fabric transfer system 42 may transport the garment on say a garment printing pallet 41, which transports a fabric or garment 12 to the pre-treatment area 10 and from there on to a printing area. Arrow 43 indicates the direction of travel. An elongated air nozzle 44 may blow hot air onto a specific area on the garment, for example forming a line of hot air which may be referred to as an air knife. A heating element 46 and an air blower 48, or alternatively a compressor, may provide the hot air to be forced through the nozzle under pressure, so that pressurized air is supplied by the blower (or compressor) through the heating element to the nozzle. The heating element and nozzle may be arranged in line with each other. The heating element 46 may for example be built into the blower or into the nozzle structure. The nozzle 44 jets the hot air onto the surface of fabric 12, as the nozzle and the fabric move relatively to one another. The hot air fuses or flexes away the unwanted pieces of fiber or fiber ends that extend outwardly from the fabric surface. In addition, the heating process also smoothens uneven weaving topography.

Reference is now made to FIG. 4, which shows, in addition to the heating element 46 and nozzle 44, a spray bar 50 for spraying liquid onto the garment prior to its passing under the air knife. A liquid jet 52 may supply liquid for spraying to the spray bar 50, and the liquid system may in an embodiment be integrated with the heat treatment mechanism. Thus, the system may be equipped with liquid sprinklers or jets, to apply liquid or a mix of liquids on the fabric prior to hot air treatment. The liquid is absorbed by the fabric and protects the fabric from overheating during treatment process.

FIG. 5 illustrates an embodiment in which two elongated nozzles 60 and 62 are suspended from a bridge 64. Each nozzle receives hot air from a heating mechanism and the nozzles are able to move from side to side over the fabric so that a line of fabric is treated each time the feed system advances the fabric. Thus, one or more blowers supply air to one or more nozzles, and the use of separate air nozzles may improve the uniformity of the air jets. A valve may be included in or upstream of the nozzles to route hot air away from fabric in off-line state, and thus prevent the fabric from burning when the feeder stops feeding the fabric.

In an embodiment, the system may include a roller to flatten the fibers in addition to applying heat from the blower.

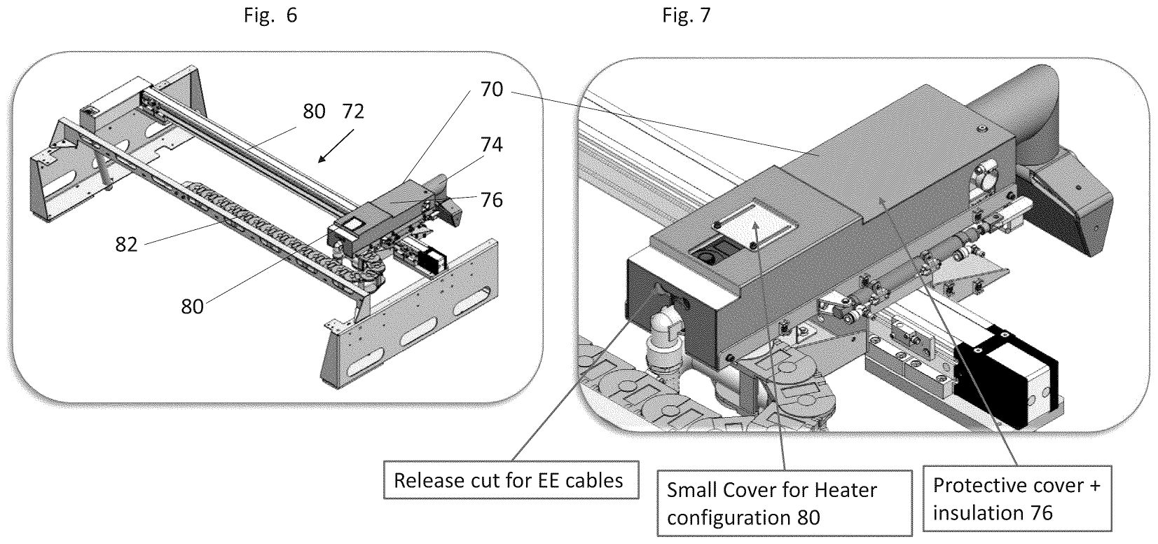

FIG. 6 is a view from above of a heating mechanism 70 on a bridge 72. The heating mechanism includes a nozzle 74 for directing the air knife at the textile and the heater and blower are housed inside protective insulating cover 76, and a removable hatch 78 provides access to the heater inside for configuration and maintenance. The mechanism moves over slider 80 under the influence of robot chain 82.

The system may have adjustable air pressure and temperature, as well as an adjustable speed for the fabric transfer system and/or the nozzle. That is to say the nozzle may be the moving part, or the nozzle may be static and operate on the fabric as the fabric is advanced past the nozzle by the feed system. In one embodiment, the feed system may advance the fabric one line at a time and one or more nozzles on a nozzle head or bridge may traverse the length of the line. Flexible control may allow optimization of the processing time required to avoid under or over processing of the fabric, as well as to optimize process parameters for different types of fabric. Thus different fabrics or mixes of fabric may be given their own processing times. In one embodiment programs may be made available to the operator to set the machine for each given kind of fabric.

In the known art, the heat press is the common solution to flatten and iron textile prior to printing. However as far as is known to the present inventors, the heat press has not been used for brushed polyester as it is deliberately not set to high enough temperatures to produce thermoplastic deformation, and if it were, it would tend to damage the garment. The non-contact embodiments herein have advantages over the heat press. For example the heat press applies mechanical pressure on the garment, which is not needed for the presently described effect. Furthermore, heat presses tend to apply heat and pressure over a fairly large area, whereas the present embodiments may apply a short heat treatment to small areas one after the other. Furthermore, by simply changing the angles of nozzles, the area can be adjusted. In addition, due to the non-contact nature of the nozzle embodiment, there is no need to adjust heights for thinner and thicker materials.

Another advantage of the present embodiments over a heat press is that possible damage or dye migration effects on the fabric may be prevented by spraying the fabric with a liquid specifically to prevent heat transfer to unwanted areas where heating is not desired.

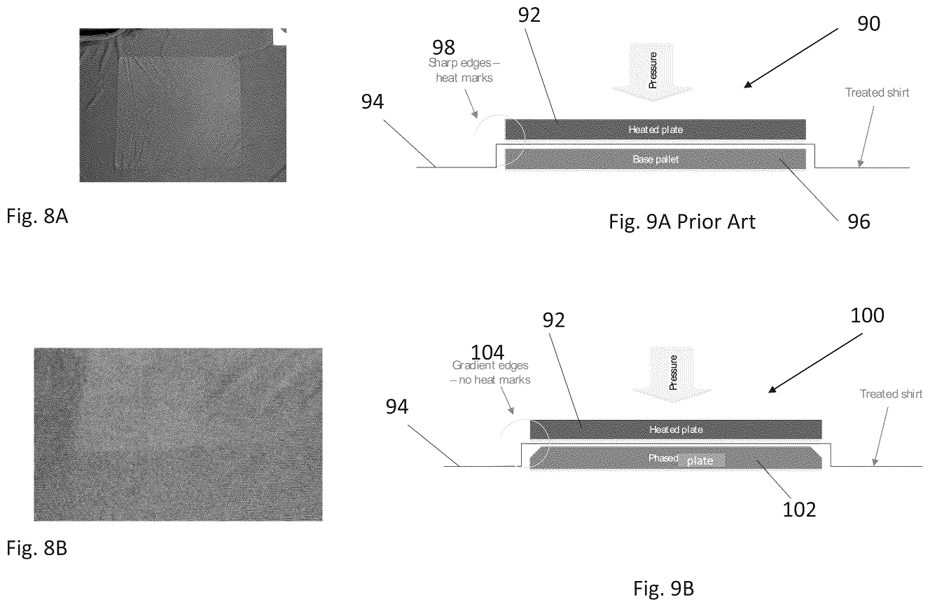

Furthermore, using a heat press on synthetic fabric may cause heat marks on the fabric due to the robust plastic deformation, as visible in accompanying FIG. 8A.

The present embodiments may provide a method and apparatus for contact heating of the fabric that uses a modification of a heat press with a structure and a method of operation that may avoid the heat marks shown in FIG. 8A, to produce the results shown in FIG. 8B. The embodiment is based on two separate parameters that work together to produce a result. Both FIGS. 8A and 8B show fabrics heated at 190 Centigrade for three seconds.

The first parameter is a time parameter. The method comprises applying the press on any given area of fabric, that is to press, for only a short time, say less than ten seconds, or more particularly less than five seconds, or less than two seconds, as opposed to regular usage of the heat press which entails pressing over 30-60 seconds. Such a reduction in the time may reduce the heat marks but is not sufficient to eliminate them.

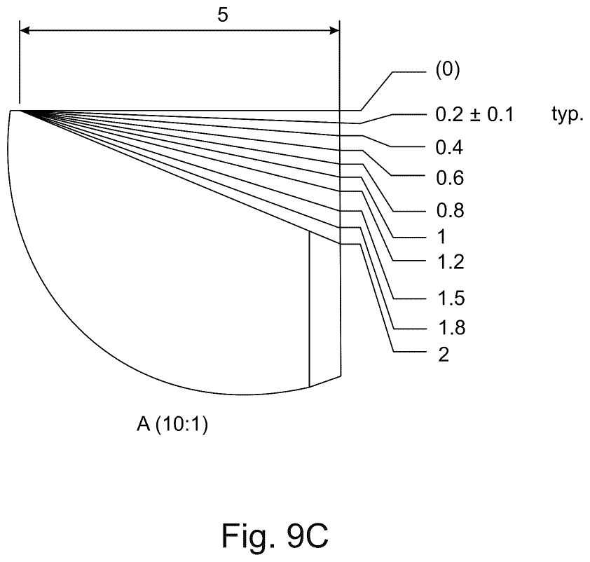

A second parameter is structural, and involves changing the contact surface of the heat press plate edges. FIG. 9A shows a conventional heat press, 90, in which a heated plate 92 is pressed down on a fabric 94 against a base pallet 96. Sharp edges 98 cause heat marks.

The revised structure 100, referred to herein as a phased plate, is shown in FIG. 9B, where, instead of the base pallet, a sloped edge phase plate 102 is used. The sloped, phase, edge is at a shallow angle, say between one and six degrees, so that the heating and pressing effect is only withdrawn gradually. The phased or sloped edge is shown at 104. Herein it is shown as part of the base, but in an embodiment the phased edge could instead be on the heated plate 92. As a result, there are no well-defined long lines formed by contact edges. The heat marks thus disappear to the naked eye since there is no visible pattern due to the fact that the phased plate gradually recedes. Nevertheless, the plastic deformation is as required on the main fiber fabric to carry out fusing of the fibers and the effect is only withdrawn gradually towards the edge. Accordingly, the amount of fusing is reduced towards the edges due to the less defined edges, so that the price of the eye not seeing the heat marks is that the printing gets slightly worse towards the edges, but the eye does not see the small gradient of change so that both the print quality reduction and the heat marks are not visible.

Reference is now made to FIG. 9C, which is a close up view of an edge 110 of the phase plate and showing different possible angles, or phases, of the sloped edge. The phase plate as used in the present embodiments in place of a standard heat press has a length of at least 5 mm and the angle of the slope, the phase, may be 1-6 degrees. The length of the step part is 0.1 mm to 0.5 mm.

The phase plate may be applied to the fabric from above or below, but typically is applied from the side on which printing is to take place.

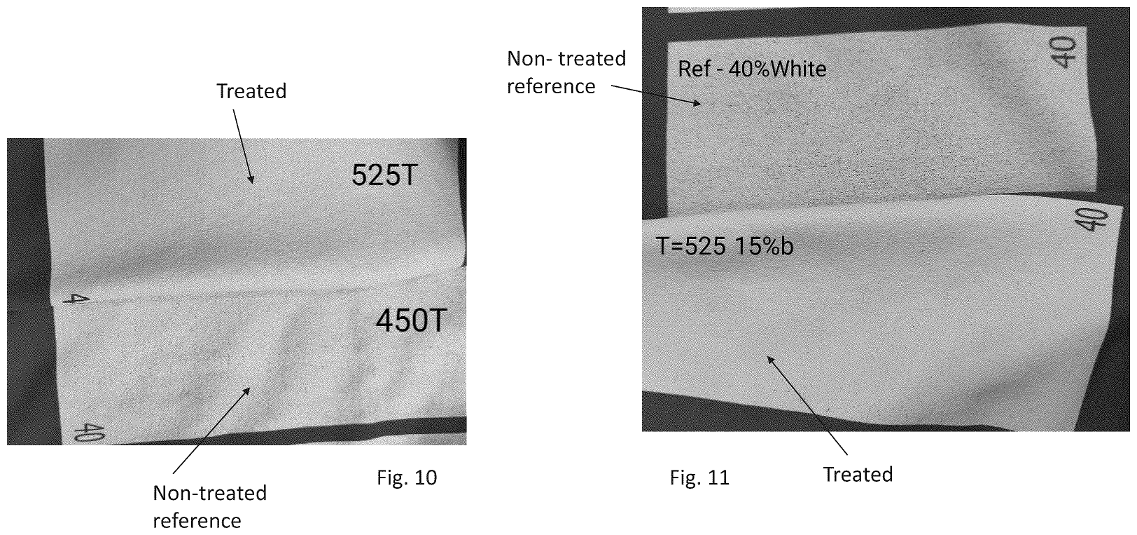

Reference is now made to FIGS. 10 and 11, which illustrate fabrics with and without application of the present embodiments. FIG. 10 shows 40% white print coverage without heat pre-treatment and with pre-treatment before the heat treatment at a temperature of 525° C.

FIG. 11 shows 40% white print coverage without heat pre-treatment and with pre-treatment including spray of 15% before the heat treatment at a temperature of 525° C.

Positive results are further obtained for treatment on wet shirts, and dye migration is avoided.

It is expected that during the life of a patent maturing from this application many relevant brushed textiles and textile mixtures will be developed and the scopes of these and other terms are intended to include all such new technologies a priori.

The terms “comprises”, “comprising”, “includes”, “including”, “having” and their conjugates mean “including but not limited to”.

The term “consisting of” means “including and limited to”.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment and the present description is to be construed as if such embodiments are explicitly set forth herein. Conversely, various features of the invention, which are, for brevity, described in the context of a single embodiment, may also be provided separately or in any suitable subcombination or may be suitable as a modification for any other described embodiment of the invention and the present description is to be construed as if such separate embodiments, subcombinations and modified embodiments are explicitly set forth herein. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. Apparatus for pre-treatment of a synthetic fabric the treatment for application prior to printing on the fabric, comprising:
a printing pre-treatment location for treating said fabric prior to providing to a printing location for printing;
a heat source configured to apply heat to a predefined printing area on said fabric at said printing pre-treatment location, said heat being sufficient to fuse outwardly extending fibers of said fabric back into said fabric using thermoplastic deformation, thereby to produce a treated printing area for printing.

2. Apparatus according to claim 1, wherein said heat source is a non-contact heat source.

3. Apparatus according to claim 2, wherein said non-contact heat source is a flame source.

4. Apparatus according to claim 2, wherein said source is heated air.

5. Apparatus according to claim 4, comprising a nozzle for providing said heated air in a directed manner at said predefined printing area.

6. Apparatus according to claim 4, wherein said heated air is heated to at least two hundred and fifty degrees Celsius.

7. Apparatus according to claim 4, wherein said heated air is sufficiently hot to heat said fabric to at least two hundred and fifty degrees Celsius.

8. Apparatus according to claim 4, wherein said source comprises an air heater for producing said heated air and a blower for blowing said heated air through said nozzle.

9. Apparatus according to claim 2, wherein said non-contact heat source comprises a laser source.

10. Apparatus according to claim 2, wherein said non-contact heat source comprises an infra-red source.

11. Apparatus according to claim 1, wherein said heat source comprises a phased plate heat press, the phased plate heat press comprising edges having a shallow receding angle.

12. Apparatus according to claim 11, wherein said phased plate heat press comprises a heating plate and a reaction plate, and said edges having a shallow angle are on said reaction plate.

13. Apparatus according to claim 11, wherein said shallow receding angle is between one and six degrees.

14. Apparatus according to claim 1, comprising a spray source for spraying the predetermined treatment area with a selected liquid prior to application of heat from said non-contact heat source, and/or after said application of heat.

15. Apparatus according to claim 14, comprising a second spray source between said non-contact heat source and said printing area, for spraying the predetermined treatment area after heating and before printing.

16. Apparatus according to claim 1, further comprising a feeder for feeding said fabric via said fabric pre-treatment location and onwards to a printing location.

17. A method of pre-treatment of synthetic fabric, the treatment for application prior to printing, comprising:
placing said fabric at a printing pre-treatment location;
applying heat to a predefined printing area on said fabric at said printing pre-treatment location, said heat fusing outwardly extending fibers of said fabric back into said fabric using thermoplastic deformation, thereby to produce a treated printing area for printing.

18. The method of claim 17, wherein said applying heat comprises heating air to a temperature suitable for thermoplastic deformation and blowing said air through a nozzle to produce a concentrated heat effect on a given location on said fabric.

19. The method of claim 17, wherein said applying heat comprises applying a contact heat element to a given location on said fabric for a time not exceeding ten seconds.

20. The method of claim 17, wherein said applying heat comprises applying a contact heat element to a given location on said fabric for a time not exceeding five seconds.

21. The method of claim 17, wherein said applying heat comprises applying a contact heat element to a given location on said fabric for a time not exceeding three seconds.
